(19) United States
(12) Patent Application Publication
(10) Pub. No.: US 2014/0211286 A1
(43) Pub. Date: Jul. 31, 2014

(54) APPARATUS AND METHOD FOR GENERATING DIGITAL HOLOGRAM

(71) Applicant: Electronics and Telecommunications Research Institute, Daejeon (KR)

(72) Inventors: Je Ho NAM, Daejeon (KR); Eun Young CHANG, Daejeon (KR); Min Sik PARK, Daejeon (KR)

(73) Assignee: Electronics and Telecommunications Research Institute, Daejeon (KR)

(21) Appl. No.: 14/166,786

(22) Filed: Jan. 28, 2014

(30) Foreign Application Priority Data
Jan. 28, 2013 (KR) 10-2013-0009154

(51) Int. Cl. G03H 1/08

(52) U.S. Cl. CPC G03H 1/0841
USPC 359/9

(57) ABSTRACT

Disclosed are an apparatus and a method for generating a digital hologram for reproducing a 3D stereoscopic image, and more particularly, an apparatus and a method for generating a digital hologram, which generate the digital hologram by receiving a depth information pre-processing process of generating first depth map information constituted by a first depth level and second depth map information constituted a second depth level by receiving color image information from an imaging unit.

This application claims the benefit of priority of Korean Patent Application No. 10-2013-0009154 filed on Jan. 28, 2013, which is incorporated by reference in its entirety herein.

### BACKGROUND OF THE INVENTION

1. Field of the Invention

The present invention relates to an apparatus and a method for generating a digital hologram.

2. Discussion of the Related Art

Holography technology is ultimate 3D stereoscopic image reproducing technology that provides a natural 3D effect to an observer by reproducing a real image based 3D image to fundamentally solve a limitation of visual representation which occurs in the existing stereoscopic method. In particular, digital holograph technology can reproduce a 3D image as if an image exists on space by an optical display method after generating a computer-generated hologram (hereinafter, referred to as CGH) with 3D information regarding a 3D object and a real image based on optical diffraction and interference principles by using a photoelectric apparatus and a computer.

In a representative CGH technique for generating a digital hologram, respective light (object wave) transmitted from point light sources constituting an object up to a hologram plane between the object and the hologram plane can be acquired by mathematically modeling a fringe pattern which is generated on the holograph plane by Fresnel diffraction and an interference phenomenon with a reference wave. In this case, depth map information is used as a method of representing 3D information of the object which is positioned on space, and the depth map information can be generated by a matching method of images acquired by a stereo or multi-view camera system constituted by two or more cameras. Since various depth cameras capable of directly acquiring the depth map information has been distributed to a market in recent years, it is anticipated that more accurate 3D second depth map information will be able to be easily secured in future.

The existing CGH generating method that generates the digital hologram is achieved on the presumption that the aforementioned 3D information or depth map information provide significantly accurate information, and as a result, the CGH generating method has been generally treated independently from a depth map generating and processing step. However, as a depth map has been directly acquired from a depth camera (e.g., Microsoft Kinect) which has been extensively distributed in recent years with ease, batch processing from a 3D image information acquiring step to a digital hologram generating step becomes available, and as a result, an integrated access that can improve the quality and generation speed of the digital hologram is required.

However, accuracy and quality of acquirable depth map data are not sufficiently satisfactory due to the limitation in performance of the depth camera at present, and as a result, the hologram generation speed as well as a 3D effect and the quality of the generated digital hologram deteriorates.

### SUMMARY OF THE INVENTION

An object of the present invention is to provide an apparatus and a method for generating a digital hologram that generate a digital hologram having more improved quality by linking a specialized depth information pre-processing process with generation of the digital hologram at the time of generating the digital hologram.

Another object of the present invention is to provide an apparatus and a method for generating a digital hologram based on depth map information, which reduce errors and improve quality in reproducing 3D stereoscopic information in a CGH generating method of the digital hologram by processing 3D depth information for each depth-level which is required to implement 2D fast Fourier transform (hereinafter, referred to as FFT) of Fresnel diffraction capable of effectively improving a generation speed of the digital hologram.

In accordance with an embodiment of the present invention, an apparatus for generating a digital hologram may include: a depth information pre-processor generating first depth map information constituted by K first depth levels and second depth map information constituted by L second depth levels by receiving color image information; and a hologram generating unit generating a digital hologram based on the second depth map information, wherein K is equal to or larger than L.

The depth information pre-processor may include a first depth map receiving unit receiving the first depth map information; a color image receiving unit receiving the color image information; a color image analyzing unit including at least one of a temporal color image analyzing unit generating temporal color image information by temporally analyzing color image information and a spatial color image analyzing unit generating spatial color image information by spatially analyzing the color image information; and a depth information analyzing unit generating the second depth map information constituted by L second depth levels based on at least one of the temporal color image information and the spatial color image information, and the first depth map information constituted by K first depth levels.

The depth information pre-processor may further include a depth information processing unit generating corrected second depth map information by performing at least one processing among modification of depth noise, removal of depth noise, modification of an error, removal of the error, and smoothing of an irregular depth effect for each of respective levels of the second depth level by receiving the second depth information for each level of the second depth level.

The hologram generating unit may include a depth-level hologram generating unit generating the hologram in each level of the second depth level by receiving the second depth map information or the second depth map information removed with the depth noise for each level of the second depth level and a depth-level hologram stacking unit generating the digital hologram capable of reproducing the 3D effect by stacking the holograms generated in the respective levels of the second depth level.

The hologram generating unit calculates and outputs the digital hologram by an equation described below.

$$u ( {x}_{2} , {y}_{2} ) = \frac{exp ( i \frac{2 π}{λ} z )}{i λ z} exp ( i \frac{π}{λ z} ( {x}_{2}^{2} + {y}_{2}^{2} ) ) \int {\int }_{- ∞}^{+ ∞} {u}^{′} ( {x}_{1} , {y}_{1} ) exp ( - i \frac{2 π}{λ z} ( {x}_{2} {x}_{1} + {y}_{2} {x}_{1} ) ) d {x}_{1} d {y}_{1} = \frac{exp ( i \frac{2 π}{λ} z )}{i λ z} exp ( i \frac{π}{λ z} ( {x}_{2}^{2} + {y}_{2}^{2} ) ) ℱ [ {u}^{′} ( {x}_{1} , {y}_{1} ) ]$$

However,

$${u}^{′} ( {x}_{1} , {y}_{1} ) = u ( {x}_{1} , {y}_{1} ) exp ( i π \frac{( {x}_{1}^{2} + {y}_{1}^{2} )}{λ z} ) , \\ ℱ [ ] ,$$

is 2D Fourier transform (FFT).
(wherein, λ represents a wavelength of a light source, u(x2,y2) represents a single hologram plane generated in each step of the second depth step, u(x1,y1) represents a depth plane for each second depth level, z represents a distance between the depth plane for each second depth level and the hologram plane u(x2,y2).)

k may be 2^{M-} in which M represents a positive integer, the L may be 2^{N} in which N represents a positive integer, however, M may be equal to or larger than N.

The temporal color image information may be generated by analyzing at least one of global temporal information of the color image information which is temporally changed in a temporally global range and localized temporal information of the color image information which is temporally changed in a temporally localized range.

The spatial color image information may be generated by analyzing at least one of boundaries of the subjects, textures of a background and a subject, and a contrast between the background and the subject constituting the color image information.

In accordance with another embodiment of the present invention, a method for generating a digital hologram may include: a depth information pre-processing step of generating first depth map information constituted by K first depth levels and second depth map information constituted by L second depth levels by receiving color image information; and a hologram generating step of generating a digital hologram by receiving the second depth map information, wherein K is equal to or larger than L.

The depth information pre-processing step may include a depth map receiving step of receiving first depth map information constituted by the K first depth levels; a color image receiving step of receiving the color image information; a color image analyzing step including at least one of generating temporal color image information by temporally analyzing color image information and generating spatial color image information by spatially analyzing the color image information; and a depth information analyzing step of generating the second depth map information constituted by L second depth levels based on at least one of the temporal color image information and the spatial color image information, and the first depth map information constituted by K first depth levels.

The depth information pre-processing step may further include a depth information processing step of generating corrected second depth map information by performing at least one processing among modification of depth noise, removal of depth noise, modification of an error, removal of the error, and smoothing of an irregular depth effect for each of respective levels of the second depth level by receiving the second depth information for each level of the second depth level.

The hologram generating step may include a depth level hologram generating step of generating a hologram in each step of a second depth level by receiving the second depth map information or corrected second depth map information for each level of the second depth level, and a hologram generating step of generating a 3D hologram by stacking the holograms generated in respective levels of the second depth level.

In the hologram generating step, the digital hologram may be calculated and output according to an equation described below.

$$u ( {x}_{2} , {y}_{2} ) = \frac{exp ( i \frac{2 π}{λ} z )}{i λ z} exp ( i \frac{π}{λ z} ( {x}_{2}^{2} + {y}_{2}^{2} ) ) \int {\int }_{- ∞}^{+ ∞} {u}^{′} ( {x}_{1} , {y}_{1} ) exp ( - i \frac{2 π}{λ z} ( {x}_{2} {x}_{1} + {y}_{2} {x}_{1} ) ) d {x}_{1} d {y}_{1} = \frac{exp ( i \frac{2 π}{λ} z )}{i λ z} exp ( i \frac{π}{λ z} ( {x}_{2}^{2} + {y}_{2}^{2} ) ) ℱ [ {u}^{′} ( {x}_{1} , {y}_{1} ) ]$$

However,

$${u}^{′} ( {x}_{1} , {y}_{1} ) = u ( {x}_{1} , {y}_{1} ) exp ( i π \frac{( {x}_{1}^{2} + {y}_{1}^{2} )}{λ z} ) , \\ ℱ [ ] ,$$

is 2D Fourier transform (FFT).

(wherein, λ represents a wavelength of a light source, u(x2,y2) represents a single hologram plane generated in each step of the second depth step, u(x1,y1) represents a depth plane for each second depth level, z represents a distance between the depth plane for each second depth level and the hologram plane u(x2,y2).)

K may be 2^{M-} in which M represents a positive integer, the L may be 2^{N} in which N represents a positive integer, however, M may be equal to or larger than N.

The temporal color image information may be generated by analyzing at least one of global temporal information of the color image information which is temporally changed in a temporally global range and localized temporal information of the color image information which is temporally changed in a temporally localized range.

The spatial color image information may be generated by analyzing at least one of boundaries of the subjects, textures of a background and a subject, and a contrast between the background and the subject constituting the color image information.

According to the present invention, a digital hologram having more improved quality can be generated by linking a pre-processing process of depth map information with generation of the digital hologram.

Further, according to the present invention, a digital hologram generation speed by processing 3D depth information for each depth-level can be effectively improved by reducing a depth-level with a color image.

According to the present invention, errors can be reduced and quality can be improved in reproducing 3D stereoscopic information by generating depth map information corrected for each level of the depth-level.

### BRIEF DESCRIPTION OF THE DRAWINGS

FIG. 1 is a configuration diagram of an apparatus for generating a digital hologram according to an embodiment of the present invention;

FIG. 2 is a configuration diagram of a color image analyzing unit according to an embodiment of the present invention;

FIG. 3 is a configuration diagram of a depth information analyzing unit according to an embodiment of the present invention;

FIG. 4 illustrates an example of the depth information analyzing unit according to the embodiment of the present invention;

FIG. 5 is a configuration diagram of a depth information processing unit according to an embodiment of the present invention;

FIG. 6 is a configuration diagram of a hologram generating unit according to an embodiment of the present invention;

FIG. 7 illustrates holograms generated in respective levels of a second depth-level and a method for stacking the holograms according to an embodiment of the present invention; and

FIG. 8 illustrates a method for generating a digital hologram according to an embodiment of the present invention.

### DETAILED DESCRIPTION OF THE EMBODIMENTS

The aforementioned content illustrates only a principle of the present invention. Therefore, those skilled in the art may implement the principle of the invention and create various devices within a concept and a scope of the invention even though not clearly described or illustrated in the specification. It should be further understood that all conditional terms and embodiments which are described in the specification are intended to understand the concept of the invention but the present invention is not limited to the embodiments and states specifically described in the specification. It shall be understood that all detailed descriptions enumerating a specific embodiment, as well as the principle, the aspect, and the embodiments of the present invention are intended to include a structural and functional equivalent thereof. Further, it shall be understood that the equivalents include an equivalent to be developed in the future, that is, every element invented so as to perform the same function regardless of a structure, as well as a currently publicly-known equivalent.

The aforementioned objects, features, and advantages will be more clear through the following detailed description associated with the accompanying drawings. In describing the present invention, when it is determined that detailed description relating to well-known functions or configurations may make the subject matter of the present disclosure ambiguous, the detailed description will be omitted. Hereinafter, preferred embodiments according to the present invention will be described with reference to the accompanying drawings in detail.

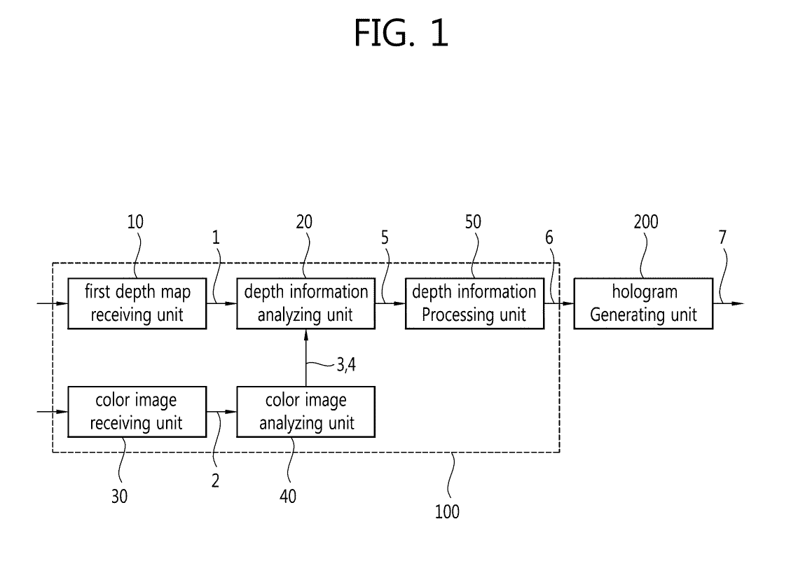

FIG. 1 is a configuration diagram of an apparatus for generating a digital hologram according to an embodiment of the present invention.

Referring to FIG. 1, the apparatus for generating a digital hologram according to the embodiment of the present invention includes a depth information pre-processor 100 and a hologram generating unit 200. The depth information pre-processor 100 may generate first depth map information 1 constituted by K first depth levels and second depth map information 5 constituted by L second depth levels by receiving color image information 2. Herein, K may be equal to or larger than L. Further, the hologram generating unit 200 according to the embodiment of the present invention may generate a digital hologram 7 based on the second depth map information 5.

Referring to FIG. 1, the depth information pre-processor 100 according to the embodiment of the present invention may include a first depth map receiving unit 10, a color image receiving unit 30, a color image analyzing unit 40, and a depth information analyzing unit 20.

The first depth map receiving unit 10 receives the first depth map information 1 constituted by K first depth levels. Herein, the first depth map information 1 constituted by K first depth levels is provided from an imaging device. Preferably, the imaging depth may be a depth camera, a plurality of stereoscopic cameras, and a plurality of multi-view cameras. Further, the first depth map information 1 may be directly acquired from the depth camera or may be formed through matching of multi-view images acquired from the plurality of stereoscopic cameras or the plurality of multi-view cameras.

The color image receiving unit 30 according to the embodiment of the present invention receives color image information. Herein, the color image information is acquired through a visible-ray based camera.

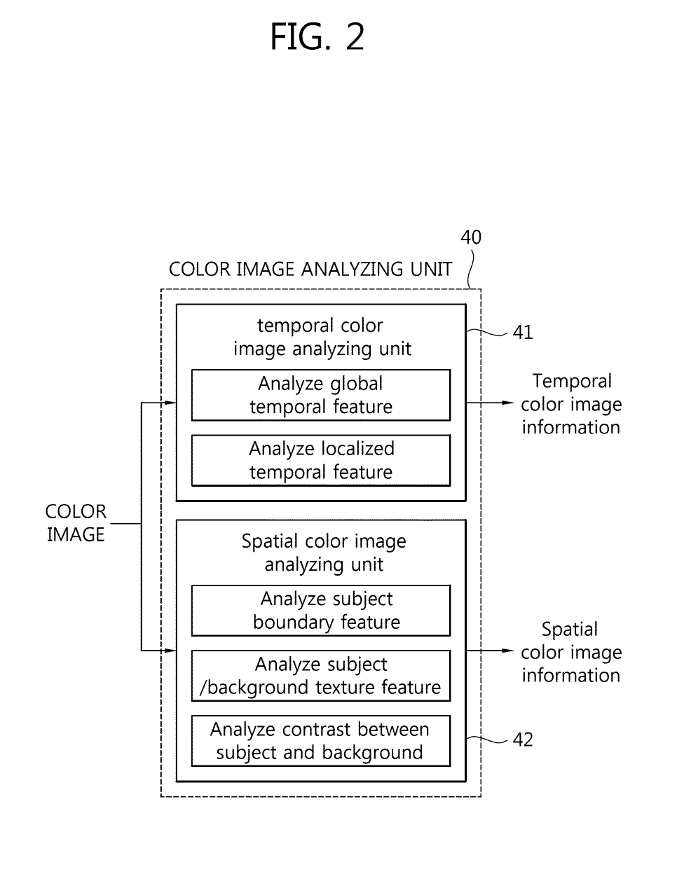

FIG. 2 illustrates the color image analyzing unit 40 according to the embodiment of the present invention, and the color image analyzing unit 40 according to the embodiment of the present invention includes at least one of a temporal color image analyzing unit 41 generating temporal color image information 3 by temporally analyzing color image information 2 and a spatial color image analyzing unit 42 generating spatial color image information 4 by spatially analyzing the color image information 2.

The color image analyzing unit 40 receives RGB color images acquired through the visible-ray based camera through the color image receiving unit 30, generates the temporal color image information 3 by temporally analyzing the color image information 2 to be suitable for generating the hologram, and generates the spatial color image information by spatially analyzing the color image information 2.

The depth information analyzing unit 20 according to the embodiment of the present invention may generate the second depth map information 5 constituted by L second depth levels based on at least one of the temporal color image information 3 and the spatial color image information 4, and the first depth map information 1 constituted by K first depth levels.

Further, the depth information pre-processor 100 according to the embodiment of the present disclosure may further include a depth information processing unit 50. The depth information processing unit 50 may generate corrected second depth map information 6 by performing at least one processing among modification of depth noise, removal of depth noise, modification of an error, removal of the error, and smoothing of an irregular depth effect for each of respective levels of the second depth level by receiving the second depth information 5 for each level of the second depth level.

K first depth levels may be equal to L second depth levels or higher than the second depth level. Preferably, k is 2^{M-} in which M represents a positive integer, the L is 2^{N} in which N represents a positive integer, however, M may be equal to or larger than N. In particular, it is more preferable that M is larger than N for high-speed processing of generating the hologram. That is, high-speed processing is available in generating the digital hologram for each depth-level by reducing K depth levels to L depth levels.

Further, the temporal color image information 3 is generated by analyzing at least one of global temporal information of the color image information 2 which is temporally changed in a temporally global range and localized temporal information of the color image information 2 which is temporally changed in a temporally localized range. The temporal color image analyzing unit 41 may analyze any one of the global temporal information of the color image information 2 which is temporally changed in a temporally global range and the localized temporal information of the color image information 2 which is temporally changed in a temporally localized range or may generate temporal color image information 3 by synthesizing and analyzing the global temporal information and the localized temporal information of the color image information 2.

Further, the spatial color image information 4 is generated by analyzing at least one of boundaries of subjects (for example, a person and a subject), textures of a background and a subject, and a contrast between the background and the subject constituting the color image information 2. The spatial color image analyzing unit 42 may generate the spatial color image information 4 by analyzing any one of at least one of the boundaries of the subjects, the textures of the background and the subject, and the contrast between the background and the subject constituting the color image information or synthesizing and analyzing two or more elements. Alternatively, the spatial color image analyzing unit 42 may generate the spatial color image information 4 by synthesizing and analyzing all of the boundaries of the subjects, the textures of the background and the subject, and the contrast between the background and the subject constituting the color image information.

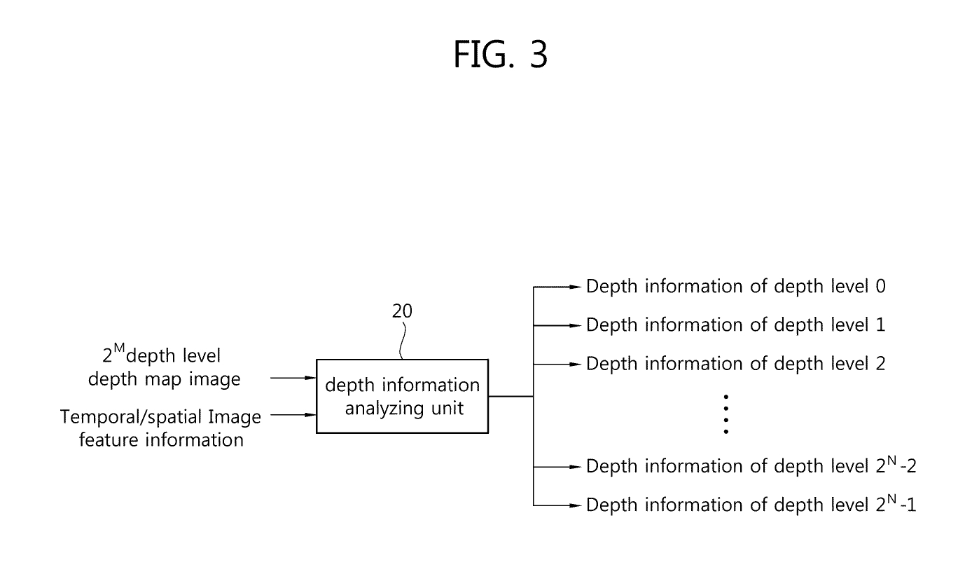

FIG. 3 illustrates the depth information analyzing unit 20 according to the embodiment of the present invention. The depth information analyzing unit 20 may generate the second depth map information 5 constituted by L second depth levels suitable for generating the digital hologram by using at least one of the temporal color image information 3 and the spatial color image information 4 received from the color image analyzing unit 40 and the first depth map information 2 constituted by K first depth levels received through the first depth map receiving unit 10.

Referring continuously to FIG. 3, the depth information analyzing unit 20 uses the first depth map information 1 constituted by 2^{M} first depth map information (e.g., M=8), and the temporal color image information 3 and the spatial color image information 4 included in a provided color image which is an analysis result of the color image analyzing unit 40. The temporal color image information may correspond to video providing in which the color image and the first depth map information 1 are temporally continued. At least one of the global temporal information of the color image information 2 which is temporally changed in the temporally global range and the localized temporal information which is concentratively changed only within the temporally localized range is analyzed to be reconfigured by the second depth map information 5 which is optimized for reproducing the hologram image so as to effectively reproduce only a depth effect degree which is recognizable by a viewer. Further, the spatial color image information 4 may be reconfigured by the second depth map information 5 which is optimized for the hologram so as to effectively reproduce the depth effect which is recognizable by the viewer by analyzing at least one of the boundaries of the subjects (for example, the person and the subject), the textures of the background and the constituent subject, the contrast, and the like constituting the color image information.

Referring continuously to FIG. 3, the depth information analyzing unit 20 reconfigures the second depth map information 5 constituted by 2^{N} second depth levels based on at least one of the temporal color image information 3 and the spatial color image information 4 received from the color image analyzing unit 40, and the first depth map information 1 constituted by 2^{M} first depth levels received from the first depth map receiving unit 10. In this case, N is equal to or smaller than M (e.g., M=8 and N=6). That is, the number of the second depth levels may be decreased to the number of the first depth levels by using the temporal color image information 3 and/or the spatial color image information 4, and further, a section interval of the second depth level may also be adaptively changed depending on the temporal color image information 3 and/or the spatial color image information 4 of the provided image. In general, the first depth map information provided to the first depth map receiving unit 10 of FIG. 10 is constituted by a first depth level of an equally spaced depth level in a depth axis (z-axis) direction, but the second depth map information 5 generated by an output result of the depth information analyzing unit 20 according to the embodiment of the present invention may be constituted by the second depth level having an unequally space depth level based on a feature of the provided image and recognition visibility of the viewer. Since the decrease of the depth level may reduce a calculation amount required when the digital hologram is generated in the hologram generating unit 200, the generation speed of the digital hologram may be continuously improved.

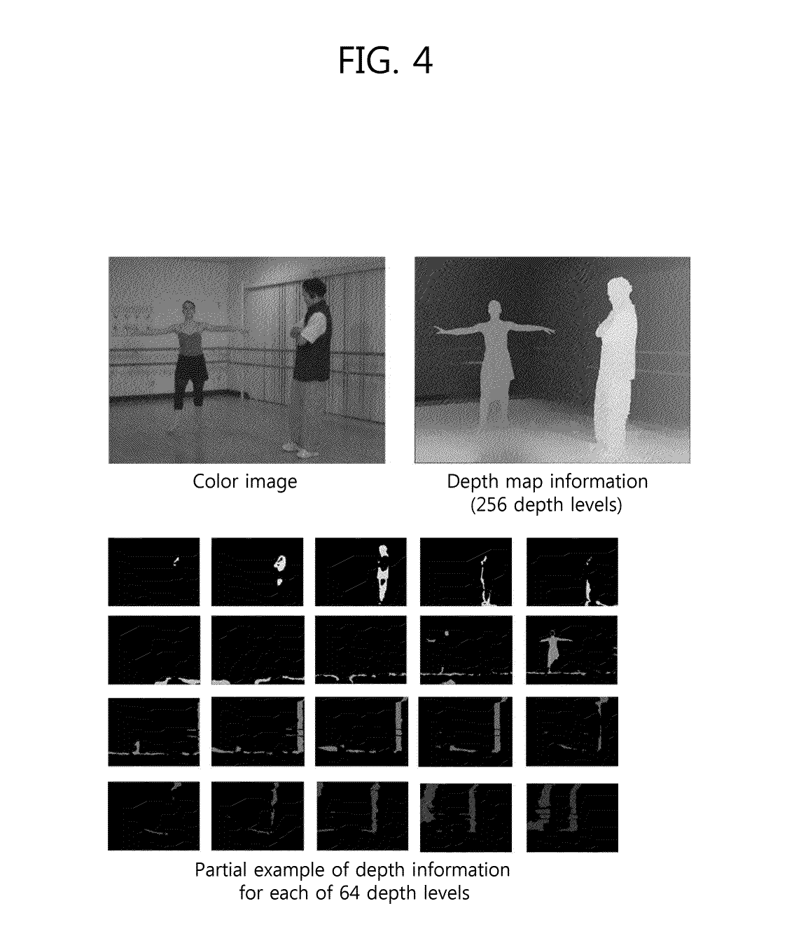

FIG. 4 illustrates the second depth map information 5 constituted by 2⁶ second depth levels based on the color image and the first depth map information 1 constituted by 2⁸ first depth levels as one example of the depth information analyzing unit 20.

Referring to FIG. 1, the depth information pre-processor 100 according to the embodiment of the present invention may further include the depth information processing unit 50. The depth information processing unit 50 according to the embodiment of the present invention may generate corrected second depth map information 6 by performing at least one processing among modification of depth noise, removal of depth noise, modification of an error, removal of the error, and smoothing of an irregular depth effect for each of respective levels of the second depth level by receiving the second depth information 5 for each level of the second depth level.

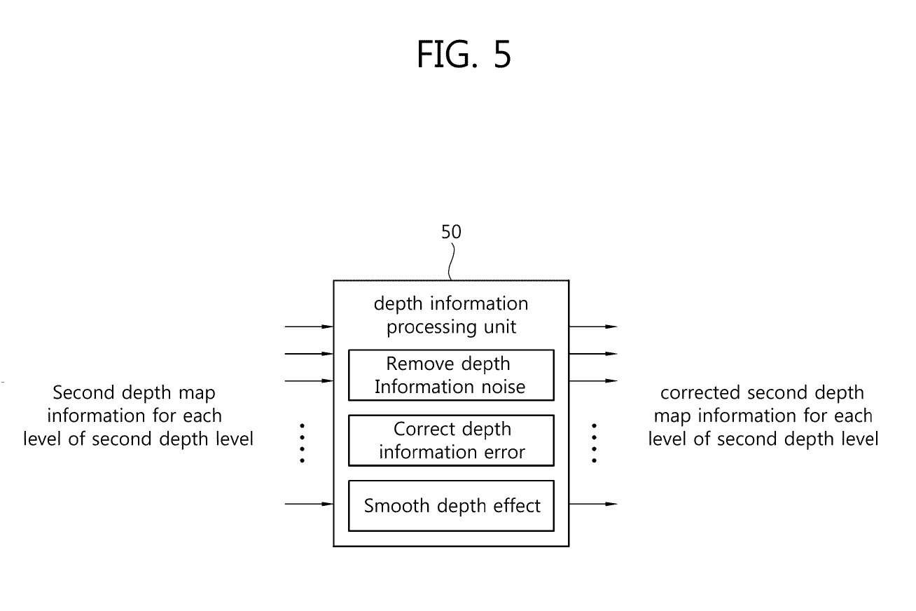

Referring to FIG. 5, the depth information processing unit 50 removes or relieves depth noise providing an occurrence factor that causes quality degradation at the time of generating the digital hologram from a spatial or temporal region. The depth noise processed by the depth information processing unit 50 means noise which has a similar value as original 3D information, but does not accurately coincide with the original 3D information as noise which is generated on a depth axis or a spatial region of an image in a pixel size or a tiny portion. Further, a case in which a large error value which remarkably distorts the original 3D information occurs as compared with the depth noise is classified as a depth error, which is distinguished from the depth noise in terms of a spatial distribution degree and temporal continuation or not of the error. In addition, in the case of the depth noise, a boundary line portion of the constituent object may be redundantly generated in several depth levels. The depth noise or depth errors are accumulated and amplified in mutual interference in the same depth level and stacking of the holograms for each depth level to cause quality degradation and an error of a finally generated hologram, at the time of generating the hologram. Therefore the depth information processing unit 50 according to the embodiment of the present invention removes or modifies the depth noise or error in order to prevent the quality degradation and the error of the hologram and smoothes the irregular depth effect to generate the corrected second depth map information 6. Of course, in some cases, only removal or modification of the depth noise may be performed, only removal or modification of the error may be performed, only smoothing of the irregular depth effect may be included, and the irregular depth effect may be smoothed together with the removal and modification of the depth noise, and the present invention is not particularly limited to the embodiment.

Therefore, according to the embodiment of the present invention, since the second depth map information 5 is corrected by the depth information processing unit 50, a 3D digital hologram having more improved quality than the existing 3D digital hologram may be generated.

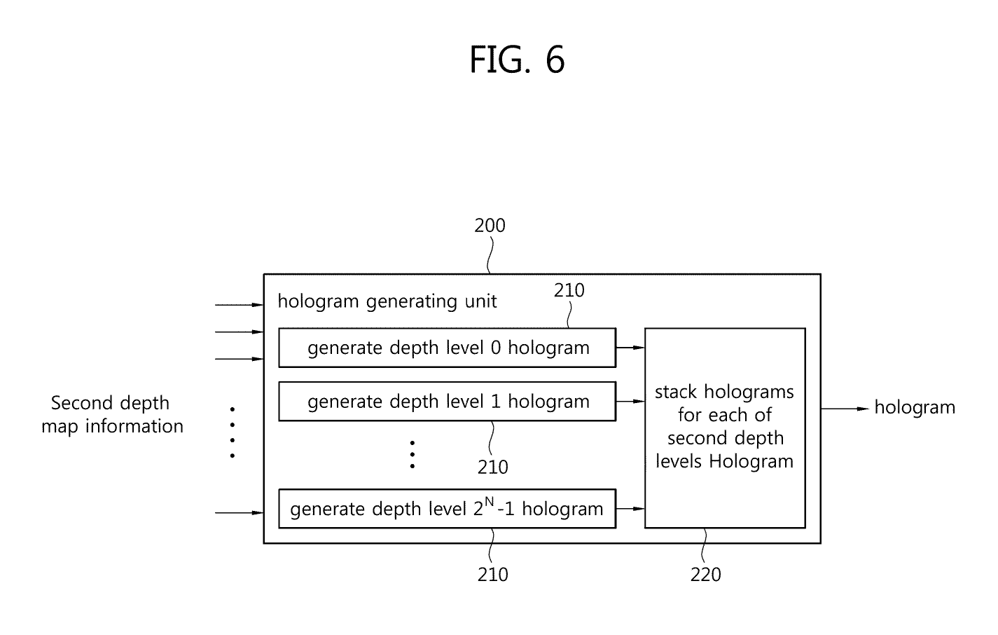

Referring to FIGS. 1 and 6, the hologram generating unit 200 according to the embodiment of the present invention generates the hologram for each level of the second depth level by receiving the second depth map information 5 or the corrected second depth map information 6 removed with the depth noise, or the like and thereafter, stacks the holograms generated in respective levels of the second depth level to finally generate a digital hologram 7 capable of reproducing a 3D effect of a target object.

Referring continuously to FIG. 6, the hologram generating unit 200 according to the embodiment of the present invention includes a depth-level hologram generating unit 210 and a depth-level hologram stacking unit 220. The depth-level hologram generating unit 210 may generate the hologram in each level of the second depth level by receiving the second depth map information 5 or the second depth map information 6 removed with the depth noise, or the like for each level of the second depth level. The depth-level hologram stacking unit 220 may generate the digital hologram 7 capable of reproducing the 3D effect by stacking the holograms generated in the respective levels of the second depth level made by the depth-level hologram generating 210.

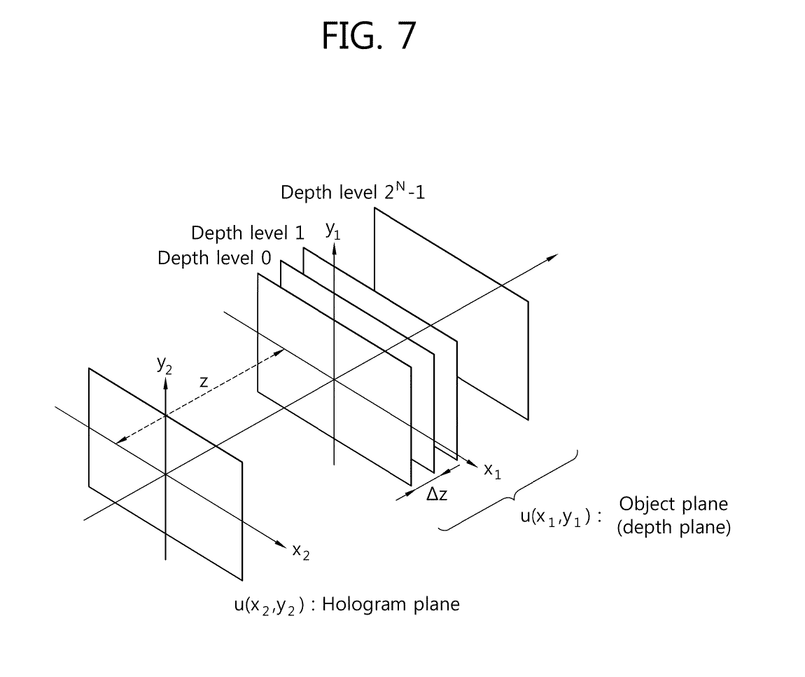

Referring to FIGS. 6 and 7, the generation and stacking of the holograms for each level of the second depth level are represented by the hologram plane for each level of the second depth level and a diffraction phenomenon of light transmitted between depth information for each level of the second depth level in FIG. 6. Representative Fresnel diffraction transformation treating the diffraction phenomenon of light is represented by [Equation 1].

$${u}_{2} ( {x}_{2} , {y}_{2} ) = \frac{exp ( i \frac{2 π}{λ} z )}{i λ z} \int {\int }_{- ∞}^{+ ∞} {u}_{1} ( {x}_{1} , {y}_{1} ) exp ( i \frac{π}{λ z} ( {( {x}_{2} - {x}_{1} )}^{2} + {( {y}_{2} - {y}_{1} )}^{2} ) ) d {x}_{1} d {y}_{1} . \qquad [ Equation 1 ]$$

However, u(x2,y2) represents a point light source configuring an object, u(x1,y1) represents one point (pixel) on a hologram plane, z represents a distance between the hologram plane and a depth plane for each depth level configuring the object, and λ represents a wavelength of a light source.

A Fresnel diffraction transformation equation of the above [Equation 1] may be more simply represented by using a 2D Fourier transformation equation. Since a high-speed algorithm to calculate Fourier transformation is widely used with being implemented in forms of software and hardware as FFT, Fresnel diffraction based on Fourier transformation of [Equation 2] is effectively used to generate the digital hologram requiring an enormous calculation amount.

$$u ( {x}_{2} , {y}_{2} ) = \frac{exp ( i \frac{2 π}{λ} z )}{i λ z} exp ( i \frac{π}{λ z} ( {x}_{2}^{2} + {y}_{2}^{2} ) ) \int {\int }_{- ∞}^{+ ∞} {u}^{′} ( {x}_{1} , {y}_{1} ) exp ( - i \frac{2 π}{λ z} ( {x}_{2} {x}_{1} + {y}_{2} {x}_{1} ) ) d {x}_{1} d {y}_{1} = \frac{exp ( i \frac{2 π}{λ} z )}{i λ z} exp ( i \frac{π}{λ z} ( {x}_{2}^{2} + {y}_{2}^{2} ) ) ℱ [ {u}^{′} ( {x}_{1} , {y}_{1} ) ] \qquad [ Equation 2 ]$$

However,

$${u}^{′} ( {x}_{1} , {y}_{1} ) = u ( {x}_{1} , {y}_{1} ) exp ( i π \frac{( {x}_{1}^{2} + {y}_{1}^{2} )}{λ z} ) , \\ ℱ [ ]$$

is 2D Fourier transform (FFT).

(wherein, λ represents a wavelength of a light source, u(x2,y2) represents a single hologram plane generated in each step of the second depth step, u(x1,y1) represents a depth plane for each second depth level, z represents a distance between the depth plane for each second depth level and the hologram plane u(x2,y2).)

According to the embodiment of the present invention, the finally generated hologram means a hologram generated by stacking single hologram planes generated in respective depth plane levels of the second depth level. Further, u(x1,y1) which is the depth plane for each second depth level of the [Equation 2] includes RGB images input on the depth plane for each second depth level. That is, 3D color image information (RGB image) in which the object is photographed is divided for each depth level of the second depth level to form u(x1,y1) which is a single 2D hologram plane.

Referring to FIG. 7, the hologram plane is generated in respective levels (for example, depth level 0, depth level 1, and the like) of the second depth level constituted by 2^{N} levels and the generated hologram planes are stacked to make a depth plane to reproduce a 3D effect of the hologram. In this case, a distance between the depth plane for each level of the second depth level and the hologram plane is represented by z.

The generation of the hologram using the Fresnel diffraction transformation equation based on the FFT of the [Equation 2] is acquired by stacking the holograms for each depth level depending on z which is the distance representing the depth plane for each depth level as illustrated in FIG. 7.

Since the generation of the hologram using the Fresnel diffraction transformation equation based on the FFT of the [Equation 2] may be applied to all generation processes of various digital holograms including an amplitude hologram, a phase-only hologram, and the like, an apparatus and a system for generating a hologram through depth information pre-processing may be commonly used to generate various holograms.

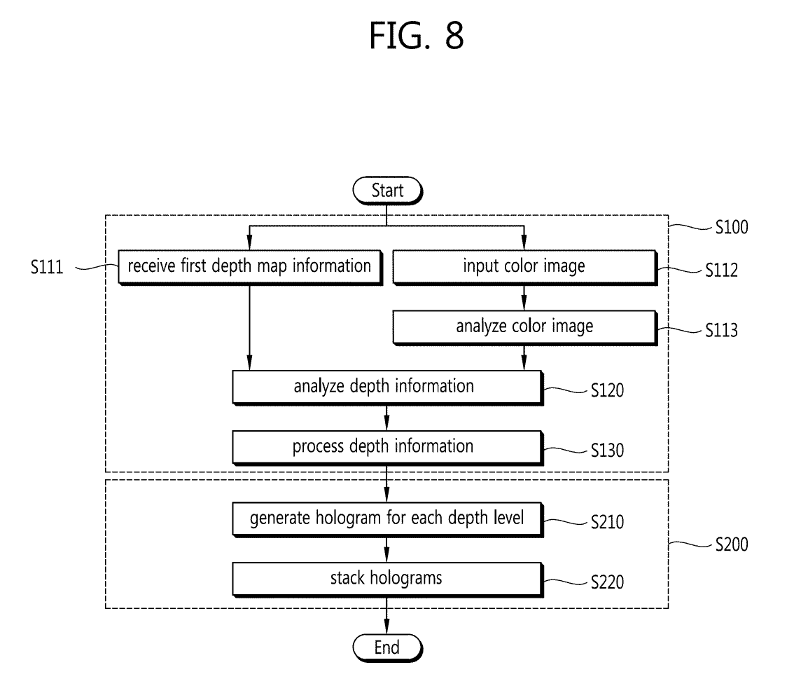

Referring to FIG. 8, a method for generating a digital hologram, which is performed by the hologram generating apparatus according to the embodiment of the present invention includes A depth information pre-processing STEP (S100) of generating first depth map information 1 constituted by K first depth levels and second depth map information 5 constituted by L second depth levels by receiving color image information 2, and a hologram generating step (S200) of generating a 3D digital hologram by receiving the second depth map information 5. Herein, K may be equal to or larger than L.

Further, the depth information pre-processing step (S100) includes a first depth map information receiving step (S111) of receiving the first depth map information 1 constituted by K first depth levels, a color image receiving step (S112) of receiving the color image information 2, a color image analyzing step (S113) including at least one of generating temporal color image information 3 by temporally analyzing the color image information 2 and generating spatial color image information 4 by spatially analyzing the color image information 2, and a depth information analyzing step (S120) of generating the second depth map information 5 constituted by L second depth levels based on at least one of the temporal color image information 3 and the spatial color image information 4 and K first depth map information 1. In addition, the depth information processing step (S100) may further include a depth information processing step (S130) of generating corrected second depth map information 6 by performing at least one processing among modification of depth noise, removal of depth noise, modification of an error, removal of the error, and smoothing of an irregular depth effect for each of respective levels of the second depth level by receiving the second depth information 5 for each level of the second depth level.

Herein, the first depth map information 1 is directly acquired from the depth camera or may be formed through matching of multi-view images acquired from the plurality of stereoscopic cameras or the plurality of multi-view cameras.

Herein, K is 2^{M-} in which M represents a positive integer, the L is 2^{N} in which N represents a positive integer, however, M may be equal to or larger than N. Further, M is preferably larger than N so that the second depth level is lower than the first depth level. When the depth level is decreased as above, a calculation amount required when the digital hologram is generated in the hologram generating step (S200) is reduced to improve the generation speed of the digital hologram as illustrated in FIG. 6.

Further, in the depth information analyzing step (S120), the temporal color image information is generated by analyzing at least one of global temporal information of the color image information which is temporally changed in a temporally global range and localized temporal information of the color image information 2, which is temporally changed within a temporally localized range, and the spatial color image information is generated by analyzing at least one of boundaries of subjects, textures of a background and a subject, and a contrast between the background and the subject.

Further, the hologram generating step (S200) according to the embodiment of the present invention may include a depth level hologram generating step (S210) of generating a hologram in each step of a second depth level by receiving the second depth map information 5 or corrected second depth map information 6 for each level of the second depth level. In addition, the hologram generating step S200 may further include a hologram stacking step (S220) of generating a 3D hologram by stacking the holograms generated in the respective levels of the second level step.

Preferably, the hologram generating step (S200) is output by calculating the digi8tal hologram according to an equation described below.

$$u ( {x}_{2} , {y}_{2} ) = \frac{exp ( i \frac{2 π}{λ} z )}{i λ z} exp ( i \frac{π}{λ z} ( {x}_{2}^{2} + {y}_{2}^{2} ) ) \int {\int }_{- ∞}^{+ ∞} {u}^{′} ( {x}_{1} , {y}_{1} ) exp ( - i \frac{2 π}{λ z} ( {x}_{2} {x}_{1} + {y}_{2} {x}_{1} ) ) d {x}_{1} d {y}_{1} = \frac{exp ( i \frac{2 π}{λ} z )}{i λ z} exp ( i \frac{π}{λ z} ( {x}_{2}^{2} + {y}_{2}^{2} ) ) ℱ [ {u}^{′} ( {x}_{1} , {y}_{1} ) ]$$

However,

$${u}^{′} ( {x}_{1} , {y}_{1} ) = u ( {x}_{1} , {y}_{1} ) exp ( i π \frac{( {x}_{1}^{2} + {y}_{1}^{2} )}{λ z} ) , \\ ℱ [ ]$$

is 2D Fourier transform (FFT).

(wherein, λ represents a wavelength of a light source, u(x2,y2) represents a single hologram plane generated in each step of the second depth step, u(x1,y1) represents a depth plane for each second depth level, z represents a distance between the depth plane for each second depth level and the hologram plane u(x2,y2).)

The technical contents according to the embodiment of the present invention described with reference to FIGS. 1 to 7 above may be applied to even the embodiment as it is. Therefore, a more detailed description will be omitted hereinbelow.

What is claimed is:

1. An apparatus for generating a digital hologram, comprising:
a depth information pre-processor generating first depth map information constituted by K first depth levels and second depth map information constituted by L second depth levels by receiving color image information; and
a hologram generating unit generating a digital hologram based on the second depth map information,
wherein K is equal to or larger than L.

2. The apparatus of claim 1, wherein the depth information pre-processor includes,
a first depth map receiving unit receiving the first depth map information;
a color image receiving unit receiving the color image information;
a color image analyzing unit including at least one of a temporal color image analyzing unit generating temporal color image information by temporally analyzing color image information and a spatial color image analyzing unit generating spatial color image information by spatially analyzing the color image information; and
a depth information analyzing unit generating the second depth map information constituted by L second depth levels based on at least one of the temporal color image information and the spatial color image information, and the first depth map information constituted by K first depth levels.

3. The apparatus of claim 2, wherein the depth information pre-processor further includes,
a depth information processing unit generating corrected second depth map information by performing at least one processing among modification of depth noise, removal of depth noise, modification of an error, removal of the error, and smoothing of an irregular depth effect for each of respective levels of the second depth level by receiving the second depth information for each level of the second depth level.

4. The apparatus of claim 1, wherein the hologram generating unit includes a depth-level hologram generating unit generating the hologram in each level of the second depth level by receiving the second depth map information or the second depth map information removed with the depth noise for each level of the second depth level and a depth-level hologram stacking unit generating the digital hologram capable of reproducing the 3D effect by stacking the holograms generated in the respective levels of the second depth level.

5. The apparatus of claim 4, wherein the hologram generating unit calculates and outputs the digital hologram by an equation described below.
$$u ( {x}_{2} , {y}_{2} ) = \frac{exp ( i \frac{2 π}{λ} z )}{i λ z} exp ( i \frac{π}{λ z} ( {x}_{2}^{2} + {y}_{2}^{2} ) ) \int {\int }_{- ∞}^{+ ∞} {u}^{′} ( {x}_{1} , {y}_{1} ) exp ( - i \frac{2 π}{λ z} ( {x}_{2} {x}_{1} + {y}_{2} {x}_{1} ) ) d {x}_{1} d {y}_{1} = \frac{exp ( i \frac{2 π}{λ} z )}{i λ z} exp ( i \frac{π}{λ z} ( {x}_{2}^{2} + {y}_{2}^{2} ) ) ℱ [ {u}^{′} ( {x}_{1} , {y}_{1} ) ]$$
However,
$${u}^{′} ( {x}_{1} , {y}_{1} ) = u ( {x}_{1} , {y}_{1} ) exp ( i π \frac{( {x}_{1}^{2} + {y}_{1}^{2} )}{λ z} ) , \\ ℱ [ ]$$
is 2D Fourier transform (FFT).
(wherein, λ represents a wavelength of a light source, u(x2,y2) represents a single hologram plane generated in each step of the second depth step, u(x1,y1) represents a depth plane for each second depth level, z represents a distance between the depth plane for each second depth level and the hologram plane u(x2,y2).)

6. The apparatus of claim 1, wherein k is 2^{M-} in which M represents a positive integer, the L is 2^{N} in which N represents a positive integer, however, M is equal to or larger than N.

7. The apparatus of claim 2, wherein the temporal color image information is generated by analyzing at least one of global temporal information of the color image information which is temporally changed in a temporally global range and localized temporal information of the color image information which is temporally changed in a temporally localized range.

8. The apparatus of claim 2, wherein the spatial color image information is generated by analyzing at least one of boundaries of the subjects, textures of a background and a subject, and a contrast between the background and the subject constituting the color image information.

9. A method for generating a digital hologram performed by a hologram generating apparatus, comprising:
a depth information pre-processing step of generating first depth map information constituted by K first depth levels and second depth map information constituted by L second depth levels by receiving color image information; and
a hologram generating step of generating a digital hologram by receiving the second depth map information,
wherein K is equal to or larger than L.

10. The apparatus of claim 9, wherein the depth information pre-processing step includes,
a depth map receiving step of receiving first depth map information constituted by the K first depth levels;
a color image receiving step of receiving the color image information;
a color image analyzing step including at least one of generating temporal color image information by temporally analyzing color image information and generating spatial color image information by spatially analyzing the color image information; and
a depth information analyzing step of generating the second depth map information constituted by L second depth levels based on at least one of the temporal color image information and the spatial color image information, and the first depth map information constituted by K first depth levels.

11. The method of claim 10, wherein the depth information pre-processing step further includes,
a depth information processing step of generating corrected second depth map information by performing at least one processing among modification of depth noise, removal of depth noise, modification of an error, removal of the error, and smoothing of an irregular depth effect for each of respective levels of the second depth level by receiving the second depth information for each level of the second depth level.

12. The method of claim 10, wherein the hologram generating step includes,
a depth level hologram generating step of generating a hologram in each step of a second depth level by receiving the second depth map information or the corrected second depth map information for each level of the second depth level, and
a hologram generating step of generating a 3D hologram by stacking the holograms generated in respective levels of the second depth level.

13. The method of claim 12, wherein in the hologram generating step, the digital hologram is calculated and output according to an equation described below.
$$u ( {x}_{2} , {y}_{2} ) = \frac{exp ( i \frac{2 π}{λ} z )}{i λ z} exp ( i \frac{π}{λ z} ( {x}_{2}^{2} + {y}_{2}^{2} ) ) \int {\int }_{- ∞}^{+ ∞} {u}^{′} ( {x}_{1} , {y}_{1} ) exp ( - i \frac{2 π}{λ z} ( {x}_{2} {x}_{1} + {y}_{2} {x}_{1} ) ) d {x}_{1} d {y}_{1} = \frac{exp ( i \frac{2 π}{λ} z )}{i λ z} exp ( i \frac{π}{λ z} ( {x}_{2}^{2} + {y}_{2}^{2} ) ) ℱ [ {u}^{′} ( {x}_{1} , {y}_{1} ) ]$$
However,
$${u}^{′} ( {x}_{1} , {y}_{1} ) = u ( {x}_{1} , {y}_{1} ) exp ( i π \frac{( {x}_{1}^{2} + {y}_{1}^{2} )}{λ z} ) , \\ ℱ [ ]$$
is 2D Fourier transform (FFT).
(wherein, λ represents a wavelength of a light source, u(x2,y2) represents a single hologram plane generated in each step of the second depth step, u(x1,y1) represents a depth plane for each second depth level, z represents a distance between the depth plane for each second depth level and the hologram plane u(x2,y2).)

14. The method of claim 9, wherein K is 2^{M-} in which M represents a positive integer, the L is 2^{N} in which N represents a positive integer, however, M is equal to or larger than N.

15. The method of claim 10, wherein the temporal color image information is generated by analyzing at least one of global temporal information of the color image information which is temporally changed in a temporally global range and localized temporal information of the color image information which is temporally changed in a temporally localized range.

16. The method of claim 10, wherein the spatial color image information is generated by analyzing at least one of boundaries of the subjects, textures of a background and a subject, and a contrast between the background and the subject constituting the color image information.

17. The apparatus of claim 3, wherein the hologram generating unit includes a depth-level hologram generating unit generating the hologram in each level of the second depth level by receiving the second depth map information or the second depth map information removed with the depth noise for each level of the second depth level and a depth-level hologram stacking unit generating the digital hologram capable of reproducing the 3D effect by stacking the holograms generated in the respective levels of the second depth level.

18. The method of claim 11, wherein the hologram generating step includes,
a depth level hologram generating step of generating a hologram in each step of a second depth level by receiving the second depth map information or the corrected second depth map information for each level of the second depth level, and
a hologram generating step of generating a 3D hologram by stacking the holograms generated in respective levels of the second depth level.
